(19) United States
(12) Patent Application Publication
(10) Pub. No.: US 2009/0211682 A1
(43) Pub. Date: Aug. 27, 2009

(54) DEVICE, IN PARTICULAR ROTARY LEADTHROUGH

(76) Inventor: Joachim Sobotzik, Lambsheim (DE)

Correspondence Address: DEERE & COMPANY, ONE JOHN DEERE PLACE, MOLINE, IL, 61265, US

(21) Appl. No.: 11/918,759

(22) PCT Filed: Apr. 18, 2006
(86) PCT No.: PCT/EP2006/061634

§ 371 Date: Dec. 4, 2008

(30) Foreign Application Priority Data
Apr. 21, 2005 (DE) 10 2005 018 584.3

(51) Int. Cl. B60C 23/00

(52) U.S. Cl. 152/415

(57) ABSTRACT

A device (30, 30′), in particular a rotary leadthrough for a tyre-filling system, is proposed. The device (30, 301) has a rotatable body (34, 34′) and a stationary body (32, 32′) and at least one chamber (106, 108, 106′, 108′) formed between the rotatable body (34, 34′) and the stationary body (32, 32′). The at least one chamber (106, 108, 106′, 108′) is delimited by opposite boundary surfaces (48, 54, 48′, 54′) of the bodies (32, 34, 32′, 34′) and by at least two sealing means (104, 104′) guided between the boundary surfaces (48, 54, 48′, 54′). At least one duct (46, 50, 52, 56, 46′, 50′, 52′, 56′) is formed in the stationary and in the rotatable body (32, 34, 32′, 34′) and issues into the at least one chamber (106, 108, 106′, 108′) between the sealing means (104, 104′). It is proposed to use sealing means (104, 104′) which are designed as brush seals. The device (30, 30′) has the advantage that, as compared with the solutions known in the prior art, there is no need for a separate pressure control duct for pressing down sealing means (104, 104′) or for providing a pressure-tight chamber (106, 108, 106′, 108′).

The invention relates to a device, in particular a rotary leadthrough for a tyre-filling system, with a body rotatable about an axis of rotation and having a first boundary surface, with a body stationary with respect to the rotatable body and having a second boundary surface, with at least one chamber formed between the rotatable body and the stationary body, the at least one chamber being delimited by the boundary surfaces of the bodies and by at least two sealing means guided between the boundary surfaces, and with at least one duct formed in the stationary and in the rotatable body and issuing between the sealing means into the at least one chamber.

Agricultural vehicles are often equipped with tyre-pressure regulating systems, by means of which the tyre pressure can be reduced, while driving during field work, to ensure a lower ground pressure, and can be increased again when driving on roads. Furthermore, the tyre pressure can thereby be adapted to different load states, and the tyre wear can be reduced. In agricultural vehicles, in this case, to fill the tyre, compressed air is routed to the wheels via a rotary leadthrough contained in the axle arrangement.

DE 199 50 191 C1 discloses a tyre-pressure regulating system with a rotary leadthrough for transferring a pressure medium from a vehicle part stationary with respect to a rotatably mounted wheel onto the said rotatably mounted wheel. The rotary leadthrough has at least one chamber which is delimited by an annular body arranged on the stator side and by an annular body arranged on the rotor side, in each case concentrically to the axis of rotation of the wheel. To seal off the chamber, sealing rings controllable via a control line are inserted between the stator-side and the rotor-side annular body. The stator-side annular body and the rotor-side annular body are arranged so as to lie next to one another with respect to the axis of rotation of the wheel, a movement gap being left between the annular bodies. Concentric annular grooves equipped with the sealing rings are introduced in the stator-side annular body, the annular grooves being connected to a control line capable of being acted upon by a pressure medium. Via a control pressure conducted into the annular grooves, the sealing rings can be moved in the direction of the rotor-side annular body and be pressed down, with the result that the chamber is closed. With the chamber closed, an exchange of pressure medium can then take place via ducts issuing into the chamber. In the pressureless state, the rotary leadthrough operates contactlessly. This has the disadvantageous effect that the control-pressure arrangement required for closing the chamber is complicated and costly. Furthermore, in the implementation of rotary leadthroughs of this type on agricultural vehicles, such as, for example, farm tractors, relatively large diameters of the sealing surfaces are required, thus giving rise to high relative speeds which entail considerable wear. In addition to this wear problem, the seals must be capable of compensating mechanical deformations and of tolerating changes occurring in the geometry to be sealed off.

The object on which the invention is based is seen in providing a device which is suitable for a tyre-filling system and by means of which one or more of the problems mentioned are overcome.

The object is achieved, according to the invention, by means of the teaching of Patent claim 1. Further advantageous refinements and developments of the invention may be gathered from the subclaims.

According to the invention, a device of the type mentioned in the introduction is designed in such a way that the sealing means are designed as brush seals. The boundary surfaces of the bodies are arranged so as to essentially face one another, so that the sealing means form, together with the boundary surfaces, a chamber closed over the circumference of the axis of rotation, the volume of the chamber being determined by the distances between the boundary surfaces or the sealing means. Brush seals are known per se and are used especially in the field of compressors, since they have a lower leakage than contactless seals (what are known as gap seals). Brush seals are contacting seals, the main item of which is a highly flexible sealing element which consists of a multiplicity of wires, fibres or threads or of a combination of these and which is matched adaptively to a surface to be sealed. Brush seals can thereby compensate for changes in a sealing gap, for example during rotor movements, so as to be virtually free of wear. Conventional brush seals are produced, for example, by a welding method, in which a sealing arrangement of wires is tensioned between two annular elements and is welded to the annular elements via a circumferential weld seam. Novel methods for producing brush seals allow the use of synthetic fibres. In this case, the brush wires or brush fibres are laid around an annular core (carrier wire) and are firmly clamped to the core by means of a clamping tube. Brush seals of this type are developed and manufactured, for example, by the company MTU. For further detailed information on brush seals, reference is hereby made to the “Engineering News” in the Internet page of MTU Aero Engines, in particular to the report “The MTU Brush Seal Design”.

Brush seals have decisive advantages, as compared with conventional seals used in tyre-filling systems. In comparison with contactless seals, brush seals have the advantage of being virtually wear-free. They have a markedly higher sealing action in relation to contactless seals, that is to say, in the case of the comparable pressure difference, their overall length (contact surface) is markedly smaller. Even in the event of a relative movement between a rotating and a stationary sealing part, brush seals operate more reliably than conventional contactless seals. In the case of a shaft standstill or at low rotational speeds, the brushes are in contact with the relatively moved sealing surface, so that a reliable sealing-off of the chamber is then ensured. At higher rotational speeds, the brushes lift off on account of aerodynamic forces. The wear is thereby reduced very greatly, with the result that very long service lives are achieved. The use of brush seals thus makes it possible to dispense with a separate arrangement for pressing down seals, such as is described, for example, in DE 199 50 191 C1 referred to in the introduction, and at the same time to achieve a high sealing property. This also consequently avoids the need for a complicated introduction of pressure-loadable annular grooves for the guidance of sealing means, which necessitates high manufacturing precision, the result of this being that a lower outlay in terms of manufacture and of cost is achieved. The chamber pressure acted upon by the at least one duct is in this case maintained by the brush seals, the leakage which occurs in the case of a brush seal being negligible or insignificant. Since the chamber is closed, virtually pressure-tight, by the sealing means, an exchange of pressure medium can take place through the ducts arranged in the rotatable body and in the stationary body, while the rotatable part is in rotation with respect to the stationary part. A rotary leadthrough is provided which makes it possible to transfer a pressure medium from one duct via the chamber into the opposite duct, without the rotational movement of the rotatable body having to be interrupted. In this case, starting from the rotatable body and from the stationary body, a plurality of ducts may issue into a chamber, with the result that the overall volume flow of a pressure-medium supply can be increased and filling or emptying times can thereby be reduced.

A plurality of chambers can be formed between the boundary surfaces by the arrangement of further sealing means or brush seals. For example, by adding a third sealing means, the first chamber is subdivided into two chambers. By a fourth sealing means, these chambers can even be designed to be completely separate from one another or even a third chamber be formed or a chamber be subdivided into three chambers by two dividing sealing means. In this case, ducts can lead into each of the chambers and make it possible to build up a pressure for sealing off the chambers virtually completely with respect to the surroundings. Preferably, three sealing means are arranged, by which two chambers are delimited. The use of brush seals in rotary leadthroughs for tyre filling makes it possible, for example, to have a rotary leadthrough for a filling volume flow for a tyre and a rotary leadthrough for a switching volume flow for a tyre valve. However, a combination of a rotary leadthrough for a filling volume flow with an electrically actuable tyre valve may likewise be envisaged.

In a preferred refinement of the invention, on at least one of the boundary surfaces of the bodies, depressions are formed, by which the sealing means can be positioned in a fixed position or in a limited position between the boundary surfaces. The sealing means are in this case preferably inserted or fitted into the depressions. The depressions are preferably designed as annular grooves arranged concentrically to the axis of rotation of the wheel and extend coaxially with respect to the axis of rotation over the entire circumference of a boundary surface. The arrangement of annular grooves for fixing the sealing means is in this case only one possible embodiment. The sealing means may, of course, also be fixed or fastened to the boundary surface in another way.

Brush seals consisting of metallic and/or non-metallic fibres or threads are suitable for use according to the invention in a rotary leadthrough for a tyre air-pressure system. In this case, various fibre-like or thread-like materials may be used which have sufficient deformability along with sufficient rigidity. Thus, for example, brush seals which have a multiplicity of bundled metal wires or metal threads or else brush seals with bundled fibres consisting of ceramic or of synthetic materials may be employed. The ducts arranged in the stationary body and in the rotatable body may be designed as discharge or supply lines operated by pressure medium. Thus, pressure medium, for example compressed air, can be routed into the chamber via the duct arranged in the stationary body and can be transferred into the duct formed in the rotatable body. Furthermore, a further duct may be formed which serves, for example, as a control line for a switching element operated by pressure medium.

In an exemplary embodiment, the rotatable body is connected to a wheel which is provided with an air-fillable tyre. The duct formed on the rotatable body in this case leads into a cavity surrounded by the tyre or is connected to the tyre cavity which, for example, can be filled with air or gas. The duct connected to the tyre cavity may in this case serve both as a filling line and as an emptying line.

A duct designed as a control line is preferably connected to a valve activatable by a pressure medium. In this case, for example, the rotatable body or components located on the rotatable body may be equipped with a valve of this type and be switched or opened or closed via the control line. It is also conceivable to switch other switching means operated by a pressure medium, for example pressure switches, via a control line of this type. A duct designed as a control line may serve, for example, to open a valve counter to a closing pressure acting on the valve and closing the valve, so that, for example, an air-filled tyre can be emptied via the control line by the valve being opened.

A least one duct is connected to a pressure-medium source which conveys the pressure medium required for the action of pressure upon a component, for example a tyre, located on the rotatable body. Preferably, for this purpose, a compressed-air pump or a compressed-air compressor is used.

The stationary body is preferably connected to a stationary axle funnel or is supported fixedly in terms of rotation on the axle funnel, so that a connection occurs between the compressed-air lines and a connection, provided on the axle funnel, to a compressed-air supply. The stationary body is connected to the axle funnel preferably via torque brackets in the form of connecting pins, connecting straps or other connecting elements.

In a preferred refinement of the invention, the boundary surfaces forming the chambers are arranged in such a way that they extend radially with respect to the axis of rotation and in the circumferential direction, so that the fibres or threads of the brush seals are oriented essentially parallel to the axis of rotation.

In an alternative refinement of the invention, the boundary surfaces forming the chambers are arranged in such a way that they extend axially with respect to the axis of rotation and in the circumferential direction, so that the fibres or threads of the brush seals are oriented essentially radially to the axis of rotation.

A device according to the invention is preferably provided on a vehicle, in particular an agricultural tractor. Thus, for example, commercial vehicles and machines from the agriculture, building and forestry sector may be equipped with devices of this type in order to implement a tyre-pressure filling system. Devices of this type are also suitable for heavy-goods vehicles or omnibuses. A device according to the invention as part of a tyre-filling system makes it possible, while driving, to adapt the tyre pressure quickly and accurately to the operating conditions (type of ground, load weight, etc.).

The invention and also further advantages and advantageous developments and refinements of the invention are described and explained in more detail below by means of the drawing which shows an exemplary embodiment of the invention and in which:

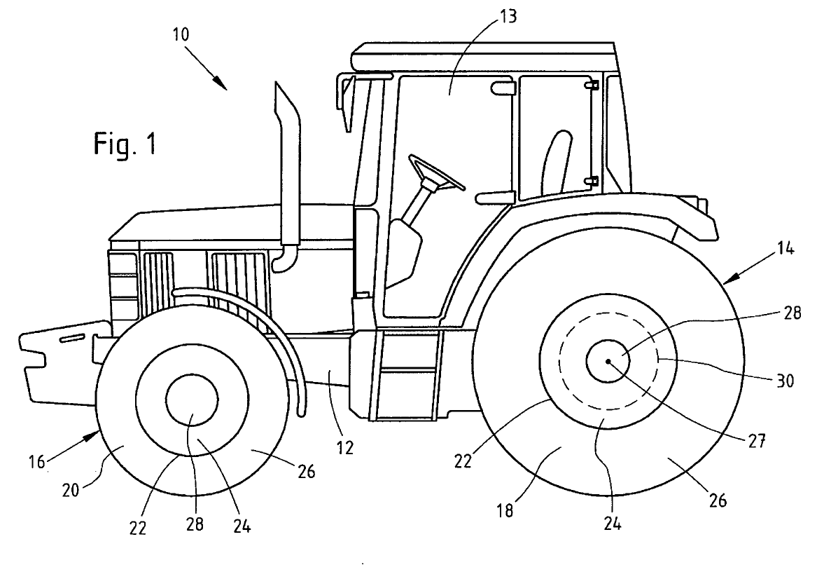

FIG. 1 shows a diagrammatic side view of an agricultural tractor with a device according to the invention,

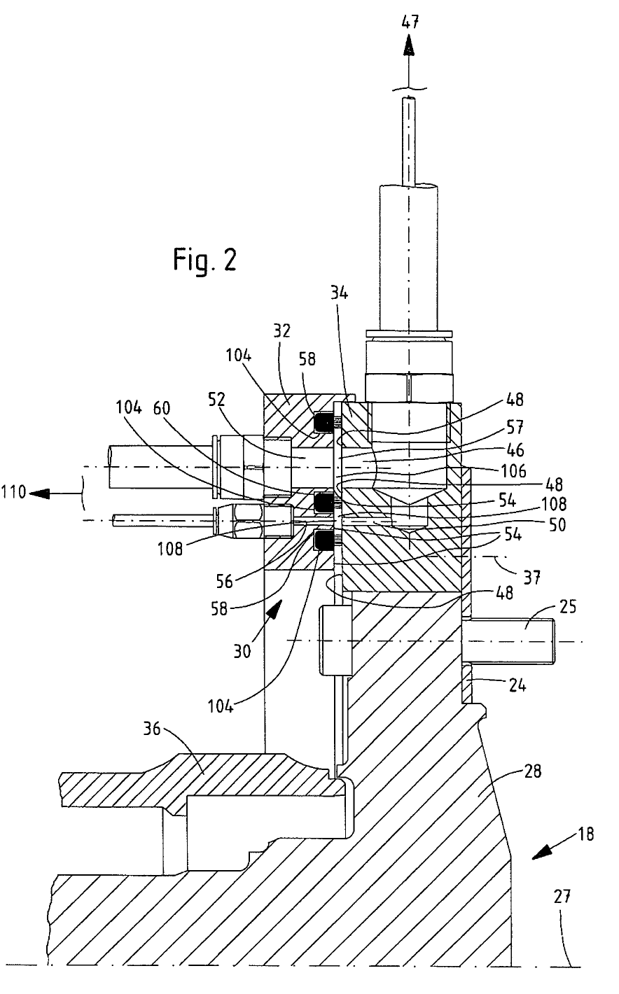

FIG. 2 shows a diagrammatic cross-sectional view of the device according to the invention from FIG. 1, and

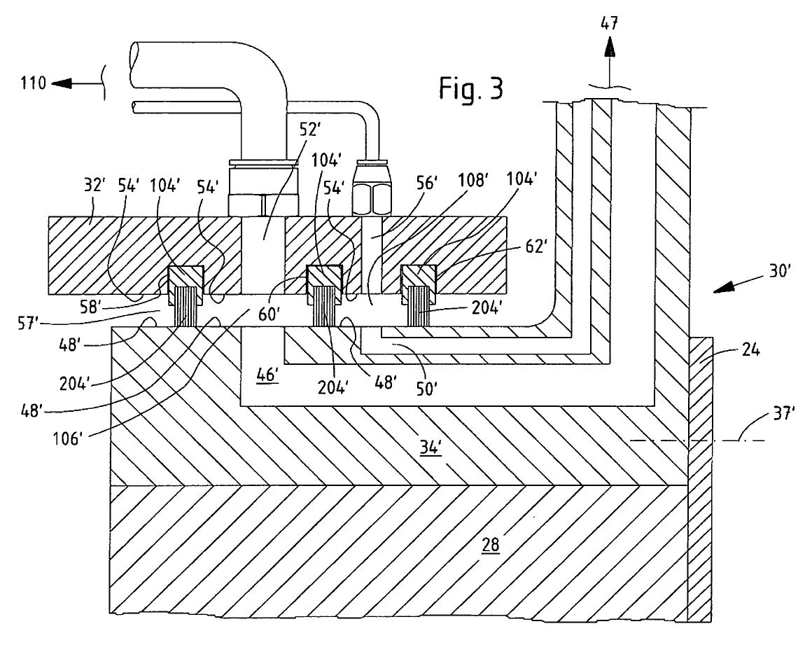

FIG. 3 shows a diagrammatic cross-sectional view of the device according to the invention in an alternative embodiment.

FIG. 1 shows an agricultural tractor 10 with a frame 12, with a cab 13, with a rear axle arrangement 14 and with a front axle arrangement 16. The axle arrangements have rear wheels 18 and front wheels 20 respectively. The wheels 18, 20 have in each case a rim structure 22 with a wheel disc 24 and also a tyre 26, the wheel discs 24 being connected via threaded bolts 25 to wheel hubs 28 arranged on the axle arrangements 14, 16 concentrically to the axis of rotation 27. The rear axle arrangement 14 is provided with a device 30 according to the invention which is designed as a rotary leadthrough of a tyre-filling system (not shown). A device 30 of this type, in the exemplary embodiment illustrated in FIG. 1, is provided on both sides of the rear axle arrangement 14, while devices 30 of this type may also be used on the front axle arrangement 16.

The device 30 has a stationary annular body or stator 32 and a rotatable annular body or rotor 34 and is illustrated in a first exemplary embodiment in FIG. 2. The stator 32 is supported in a way not illustrated on an axle body 36 surrounding a drive train (not shown) of the tractor 10. The wheel 18 is held by bearing arrangements (not shown) which extend between the axle body 36 and the wheel hub 28. The rotor 34 is mounted on the wheel hub 28 and is connected fixed to the latter, for example via screw connections 37 (not shown in detail) to the wheel disc 24. The wheel hub 28 is connected on the drive side to the drive train (not shown) of the tractor 10 and on the output side to the wheel disc 24.

In the rotor 34, a first duct 46 is formed, which, running at right angles, starting from an extent essentially radial with respect to the axis of rotation 27, issues at a first boundary surface 48 extending essentially radially with respect to the axis of rotation 27, the first boundary surface 48 forming an outer surface of the rotor 34, the said outer surface being directed to the drive side of the tractor 10. The first duct 46 issues, in its direction leading away from the boundary surface 48, into a pressure-activatable tyre valve 47 or makes a connection to the tyre 26.

In the rotor 34, a second duct 50 is formed, which, running at right angles, starting from an extent essentially radial with respect to the axis of rotation 27, likewise issues at the first boundary surface 48. The second duct 50 issues in its direction leading away from the boundary surface 48 into the tyre valve 47 and constitutes a control line for opening the tyre valve 47, so that the tyre valve 47 can be opened by pressure-medium control via the second duct 50.

In the stator 32, a third duct 52 is formed which runs essentially axially with respect to the axis of rotation 27 and which issues at a second boundary surface 54 extending essentially radially with respect to the axis of rotation 27, the second boundary surface 54 forming an outer surface of the stator 34, the said outer surface being directed to the output side of the tractor 10.

In the stationary body 32, a fourth duct 56 is formed which runs essentially axially with respect to the axis of rotation 27 and which likewise issues at the second boundary surface 54.

A movement gap 57 is formed between the boundary surfaces 48 and 54, so that the rotor 32 can rotate freely with respect to the stator 34.

The second boundary surface 54 on the stator 32 has depressions 58, 60, 62 extending axially with respect to the axis of rotation 27 and arranged concentrically to the axis of rotation 27, the depressions 58, 60, 62 in each case forming an annular groove formed over the circumference of the stator 32. The design of the depressions 58, 60, 62 is in this case selected such that the annular grooves formed by the depressions 58, 60, 62 have different average radii with respect to the axis of rotation 27. In the example illustrated in FIG. 2, three depressions 58, 60, 62 are formed on the second boundary surface 54, the annular groove formed by the depression 58 having the largest average radius and the annular groove formed by the depression 62 having the smallest average radius.

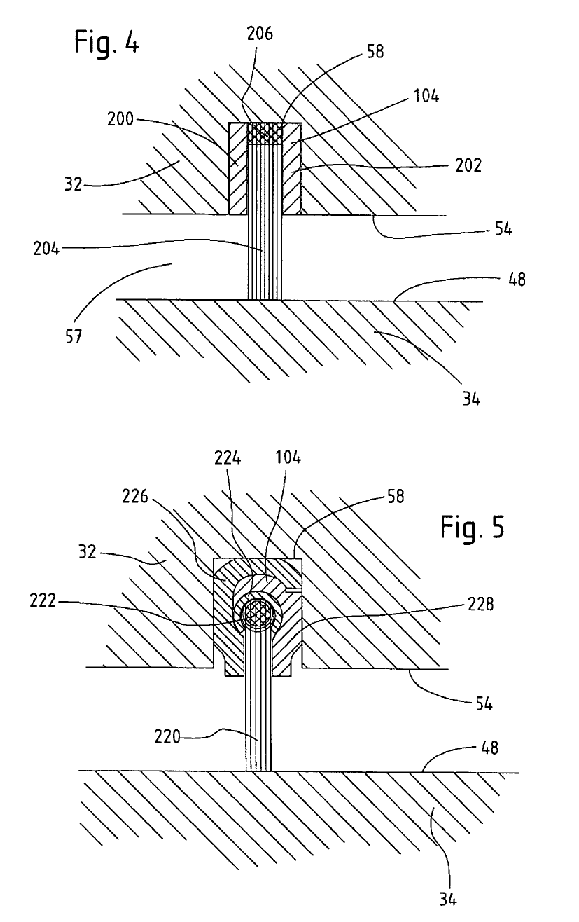

Sealing means 104 designed as brush seals are arranged in the annular grooves formed by the depressions 58, 60, 62. Such sealing means 104 designed as brush seals are illustrated in FIGS. 4 and 5. FIG. 4 shows a first embodiment in which the sealing means 104 has a first and a second annular disc 200, 202. Between the annular discs 200, 202 are arranged a multiplicity of fibres or wire threads 204 which are manufactured from thin metal wires. The wire threads 204 are welded to one another and the two annular discs 200, 202 by means of a weld seam 206. The annular discs 200, 202 serve at the same time as supporting discs for supporting the wire threads 204. The annular discs 200, 202, the weld seam 206 and the multiplicity of wire threads 204 are dimensioned such that they form a fit with the depressions 58 and can be fixed there. The wire threads 204 extend in the axial direction with respect to the axis of rotation 27 as far as the first boundary surface 48 on the rotor 34, so that the movement gap 57 formed between the boundary surfaces 48, 54 is sealed off by the wire threads 204.

An alternative embodiment of the sealing means 104 designed as a brush seal is illustrated in FIG. 5. In this case, a multiplicity of fibres or threads 220 are laid round a wire core 222 designed as a ring and are clamped firmly onto the wire core 222 by a clamping ring 224. Around the clamping ring 224 are laid annular profiles 226, 228 which tension the clamping ring 224 and consequently also the multiplicity of threads 220 laid around the wire core 222. The annular profiles 226, 228 serve at the same time as supporting discs for the threads 220 and as shims for the sealing means 104, the annular profiles 226, 228 being dimensioned such that they form a fit with the depressions 58 and can be fixed there. The threads 220 extend in the axial direction with respect to the axis of rotation 27 as far as the first boundary surface 48 on the rotor 34, so that the movement gap 57 formed between the boundary surfaces 48, 54 is sealed off by the threads 220. This embodiment has the advantage that the threads 220 are connected or fixed to one another by means of a clamping ring 224, so that a weld seam 206 according to the example from FIG. 4 may be dispensed with. As a result, other non-metallic threads 220 or fibres consisting of synthetic material or ceramic may also be used.

In both of the exemplary embodiments of the sealing means 104 which are shown in FIGS. 4 and 5, the axial distance between the boundary surfaces 48, 54 and the length of the threads 204, 220 of the sealing means 104 are selected such that the sealing means 104 bear with the threads 204, 220 against the boundary surface 48 in a sealing-off manner. The sealing means 104 designed as brush seals have only a very low wear and because of the high thread or fibre density possess a very good sealing action or low leakage. The high sealing action is maintained even in the event of relative speeds between the stator 32 and rotor 34, the leakage increasing with an increasing rotational speed of the rotor 34. The sealing means 104 designed as brush seals nevertheless operate more reliably than conventional shaft seals or contact seals. In particular, dimensional inaccuracies on the boundary surfaces 48 or on the sealing surfaces can be tolerated, since the fibre or thread bundles 204, 220 of a brush seal can adapt to the surface changes caused by dimensional inaccuracies. Without any rotation, for example when a tyre 26 of a stationary tractor 10 is being filled, brush seals generate a comparatively good sealing action.

The sealing means 104 arranged in the depressions 58, 60, 62 form a leak-tight first chamber 106 between the depressions 58, 60 and a leak-tight second chamber 108 between the depressions 60, 62, the chambers 106, 108 being delimited radially by the sealing means 104 and axially by the boundary surfaces 48, 54. The first duct 46 and the third duct 52 in this case issue into the first chamber 106 and the second duct 50 and the fourth duct 56 issue into the second chamber 108.

The device 30 illustrated in FIG. 2 serves as rotary leadthrough for a tyre-filling system on a tractor 10, the leadthrough taking place in the axial direction, that is to say the boundary surfaces 48, 54 formed on the stator 32 and on the rotor 34 are designed to be spaced apart axially with respect to the axis of rotation 27. The third duct 52 formed in the stator 32 is connected to a pressure source 110 which, to fill the tyre 26, conveys compressed air into the third duct 52. The compressed air in this case flows into the first chamber 106 and from there into the first duct 46. During the build-up of pressure or the supply of compressed air, the rotor 34 can maintain its rotational movement or rotary movement with respect to the stator 32. The tyre valve 47 provided on the tyre 26 opens with the supply of compressed air in the direction of the tyre 26, so that compressed air can flow out of the third duct 52 via the first chamber 106 and via the first duct 46 into the tyre 28. As soon as the supply of compressed air from the third duct 52 is interrupted, the tyre valve 47 closes automatically due to the pressure acting from the tyre 26.

The fourth duct 56 formed in the stationary part 32 is likewise connected to the pressure source 110, the pressure source 110 being connected only for emptying the tyre 26, so that, to empty the tyre 26, compressed air is conveyed into the fourth duct 56. The compressed air in this case flows into the second chamber 108 and from there into the second duct 50. The second duct 50 is connected to the tyre valve 47 in such a way that the compressed air flowing into the second duct 50 opens the tyre valve 47, so that the air contained in the tyre 26 can flow through the tyre valve 47 into the first duct 46 and from there via the first chamber 106 into the third duct 52. The air can be discharged from there into the surroundings by means of a venting valve (not shown). As soon as the supply of compressed air to the fourth duct 56 is interrupted again, the wheel valve 47 closes automatically under the pressure prevailing in the tyre 26. The activation of the pressure supply or the activation of the venting valve takes place by means of a suitable control device which is installed in the cab 13 of the tractor 10.

FIG. 3 shows an alternative exemplary embodiment of a device 30′ for a rotary leadthrough of a tyre-filling system. The device 30′ constitutes an exemplary embodiment in which the rotary leadthrough takes place in a direction radial with respect to the axis of rotation 27, that is to say the boundary surfaces 48′, 54′ formed on the stator 32′ and on the rotor 34′ are designed to be spaced apart radially with respect to the axis of rotation 27. Functioning is essentially identical to the functioning of the example illustrated in FIG. 2, the individual differences being described below. The boundary surface 48′ is designed as a boundary surface 48′ extending axially with respect to the axis of rotation 27 and in the circumferential direction and directed radially outwards. The boundary surface 54′ is designed as a boundary surface 54′ extending axially with respect to the axis of rotation 27 and in the circumferential direction and directed radially inwards. Furthermore, the sealing means 104′ designed as brush seals are designed in such a way that the threads 204′ (or according to the embodiment of the threads 220 described in FIG. 5) extend correspondingly radially with respect to the axis of rotation 27 in the direction of the boundary surface 48′ of the rotor 34′ and seal off the boundary surface 48′, the sealing means 104′ otherwise having an identical function and property and also an identical set-up to the sealing means 104 of the example from FIG. 2. The depressions 58′, 60′, 62′ for receiving or fixing the sealing means 104′ are formed on the boundary surface 54′ of the stator 32′ and constitute three annular grooves which are spaced apart axially with respect to the axis of rotation 27 and which extend over the entire circumference of the boundary surface 54′. The ducts 46′, 50′ formed in the rotor 34′ have a u-shaped run, so that the ducts 46′, 50′ issue into the chambers 106′, 108′ delimited by the sealing means 104′. The rotor 34′ is connected in the same way, for example via screw connections 37′, to the wheel disc 24 or the wheel hub 28. Here, too, the stator 32′ is connected (not shown) to the axle body 36. The filling and emptying of the tyre 26 take place in the same way as in the example illustrated in FIG. 2.

Even though the invention has been described solely with reference to an exemplary embodiment, many different alternatives, modifications and variants which come under the present invention will become clear to a person skilled in the art in the light of the above description and the drawing. Thus, for example, the arrangement of the ducts 50, 56, and 50′, 56′ may be dispensed with and an electrically operated tyre valve 47 be used. Consequently, one sealing means 104 or 104′ and consequently the chamber 108 or 108′ would be dispensed with and only the chamber 106 or 106′ for the transfer of compressed air would be sealed off by two adjacent sealing means 104 or 104′.

1. Device, in particular a rotary leadthrough for a tyre-filling system, with a body (34, 34′) rotatable about an axis of rotation (27) and having a first boundary surface (48, 48′), with a body (32, 32′) stationary with respect to the rotatable body (34, 34′) and having a second boundary surface (54, 54′), with at least one chamber (106, 108, 106′, 108′) formed between the rotatable body (34, 34′) and the stationary body (32, 32′), the at least one chamber (106, 108, 106′, 108′) being delimited by the boundary surfaces (48, 54, 48′ 54′) of the bodies (34, 32, 34′, 32′) and by at least two sealing means (104, 104′) extending between the boundary surfaces (34, 32, 34′, 32′), and with at least one duct (46, 50, 52, 56, 46′, 50′, 52′, 56′) formed in the stationary and in the rotatable body (32, 34, 32′, 34′) and issuing into the at least one chamber (106, 108, 106′, 108′) between the sealing means (104, 104′), characterized in that the sealing means (104, 104′) are designed as brush seals.

2. Device according to claim 1, characterized in that one or more further chambers (106, 108, 106′, 108′) delimitable by one or more further sealing means (104, 104′) are formed between the first and the second boundary surface (48, 54, 48′, 54′).

3. Device according to one of the preceding claims, characterized in that, on at least one of the boundary surfaces (48, 54, 48′, 54′), depressions (58, 60, 62, 58′, 60′, 62′) are formed, in which the brush seals (104, 104′) are guided, fixed in position, between the boundary surfaces (48, 54, 48′, 54′).

4. Device according to one of the preceding claims, characterized in that the brush seals (104, 104′) have metallic and/or non-metallic fibres or threads.

5. Device according to one of the preceding claims, characterized in that the at least one duct (46, 50, 52, 56, 46′, 50′, 52′, 56′) is designed as a discharge and/or supply and/or control line operated by a pressure medium.

6. Device according to one of the preceding claims, characterized in that the at least one duct (46, 50, 52, 56, 46′, 50′, 52′, 56′) can be connected to a tyre (26) fillable with pressure medium.

7. Device according to one of the preceding claims, characterized in that the at least one duct (46, 50, 52, 56, 46′, 50′, 52′, 56′) can be connected to a valve (47) activatable by pressure medium.

8. Device according to one of the preceding claims, characterized in that the at least one duct (46, 50, 52, 56, 46′, 50′, 52′, 56′) can be connected to a pressure-medium source (110), in particular to a compressed-air source.

9. Device according to one of the preceding claims, characterized in that the stationary body (32, 32′) is connected to a stationary axle body (36).

10. Device according to one of the preceding claims, characterized in that the boundary surfaces (48, 54, 48′, 54′) extend radially with respect to the axis of rotation (27).

11. Device according to one of claims 1 to 9, characterized in that the boundary surfaces (48, 54, 48′, 54′) extend axially with respect to the axis of rotation (27).

12. Vehicle with a device (30, 30′) according to one or more of the preceding claims.
